(19) United States
(12) Patent Application Publication
(10) Pub. No.: US 2011/0133926 A1
(43) Pub. Date: Jun. 9, 2011

(54) TOW TEAM COMMUNICATION SYSTEM

(76) Inventor: DAVID MOMQUIST, Tulsa, OK (US)

(21) Appl. No.: 12/634,177

(22) Filed: Dec. 9, 2009

(51) Int. Cl. G08B 1/08

(52) U.S. Cl. 340/539.11

(57) ABSTRACT

The invention relates to a tow team communication system. More specifically, the invention relates to an apparatus that assists with the process of moving very large objects with the following elements: 1) a signal generating means adapted to be held or attached to a person or object, 2) a means for receiving a signal from the signal generating means, and for generating an audible and/or visual alarm as a result of receiving a signal from the signal generating means, and 3) a headset for receiving a signal from the signal generating means, and for generating an audible and/or visual alarm as a result of receiving a signal from the signal generating means.

### CROSS-REFERENCE TO RELATED APPLICATIONS

None.

### STATEMENT REGARDING FEDERALLY SPONSORED RESEARCH OR DEVELOPMENT

None.

### THE NAMES OF THE PARTIES TO A JOINT RESEARCH AGREEMENT

None.

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

None.

### BACKGROUND OF THE INVENTION

1. Field of the Invention

The present invention relates generally to communication systems. More particularly, the present invention relates to communication systems that use light and sound to communicate between multiple parties simultaneously and that can be used under conditions in which normal communication is not easily achieved.

2. Description of Related Art

Movement of very large objects—vehicles, machinery, and equipment—(hereinafter referred to as “VLO”) is often accomplished by the coordinated efforts of multiple individuals. The success or failure of the movement of a VLO depends on the ability or inability of the individuals tasked with moving the VLO to effectively communicate with one another and complete their assigned task simultaneously. Some individuals may be tasked with operating the VLO, others with observing and guiding the VLO, others may be tasked with operating a tug, and still others observing and supervising the operation from afar.

Communication between individuals charged with the safe movement of a VLO is of the highest importance. The inability to communicate can result in harm to people and or property in the proximity of the VLO while it is being moved. Communication is often accomplished by walkie-talkies, hand signals, or other similar means. Unfortunately, movement of VLOs often takes place under circumstances in which normal communication is not easily achieved (for example due to extreme noise or darkness). Current methods of communication are often inadequate and lead to problems when moving VLOs.

### BRIEF SUMMARY OF THE INVENTION

The invention relates to a tow team communication system. More specifically, the invention relates to an apparatus that assists with the process of moving VLOs with the following elements: 1) a signal generating means adapted to be held or attached to a person or object, 2) a means for receiving a signal from the signal generating means, and for generating an audible and/or visual alarm as a result of receiving a signal from the signal generating means, and 3) a headset for receiving a signal from the signal generating means, and for generating an audible and/or visual alarm as a result of receiving a signal from the signal generating means.

### BRIEF DESCRIPTION OF THE SEVERAL VIEWS OF THE DRAWINGS

A preferred embodiment of the present invention is described in detail below with reference to the attached drawing figures, wherein:

FIG. 1 illustrates a view of the preferred embodiment of the signal generating means.

FIG. 2 illustrates a view of the means for receiving a signal from the signal generating means, and for generating an audible and/or visual alarm as a result of receiving a signal from the signal generating means.

FIG. 3 illustrates a view of the headset for receiving a signal from the signal generating means, and for generating an audible and/or visual alarm as a result of receiving a signal from the signal generating means.

FIG. 4 illustrates a view of the disclosed invention in use.

### DETAILED DESCRIPTION OF THE INVENTION

The embodiments discussed herein are merely illustrative of specific manners in which to make and use the invention and are not to be interpreted as limiting the scope of the instant invention.

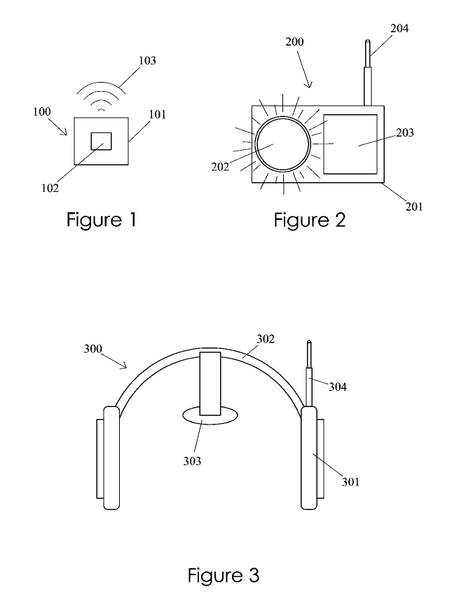

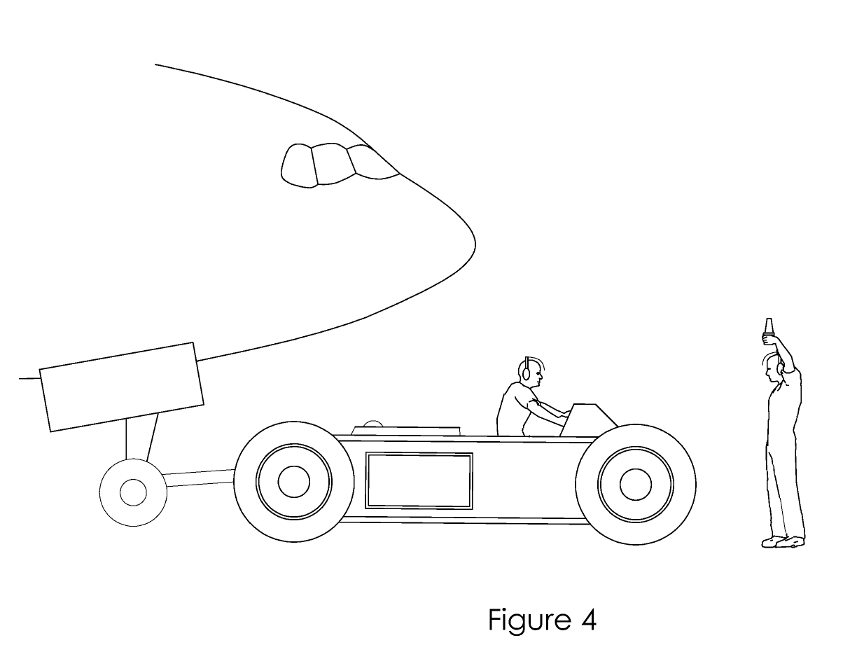

Referring to the drawings in detail, FIG. 1 illustrates a view of the preferred embodiment of the signal generating means 100. Generally, the signal generating means includes a housing 101 (encasing the electronic components not shown) with a button or switch 102 located thereon. When the button or switch is activated, a signal is generated and emitted 103 which is then received by the remaining elements of the disclosed invention. Signal generating means and the electronic components used therein are not novel and are very well known in the prior art and to those skilled in the art and include, but are not limited to, car alarm devices, garage door openers, remote ignition devices, remote operating devices, etc.

FIG. 2 illustrates a view of the means for receiving a signal from the signal generating means, and for generating an audible and/or visual alarm as a result of receiving a signal from the signal generating means 200. Generally, the signal receiving means includes a housing 201 (encasing the electronic components not shown) with a speaker capable of generating an audible alarm 202 and light source 203 located thereon. Also shown is an antenna 204 that may, however, be enclosed in the housing with the other electronic components. When a signal is received from the signal generating means, the light signal and/or audible alarm from the speaker are activated and displayed by the signal receiving means. The audible alarm may be in the form of a siren or spoken words. As with the signal generating means, signal receiving means and the electronic components used therein are not novel and are very well known in the prior art and to those skilled in the art and include, but are not limited to, car alarm devices, garage door openers, remote ignition devices, remote operating devices, etc. The signal receiving means may be patched directly into or connected to the communication system of the VLO by a standard audio connecting cord connection between the signal receiving means and the communication system of the VLO.

FIG. 3 illustrates a view of the headset for receiving a signal from the signal generating means, and for generating an audible and/or visual alarm as a result of receiving a signal from the signal generating means 300. Generally, the headset includes at least one head phone unit 301, a head band portion 302, and a light unit 303 protruding from the head band portion. Also shown is an antenna 304 that may, however, be mounted along or inside the head band portion of the headset. When a signal is received from the signal generating means, the light signal and/or audible alarm from the head phone unit(s) are activated and displayed by the headset. The audible alarm may be in the form of a siren or spoken words. Wireless headsets and headphones and the electronic components used therein are not novel and are very well known in the prior art and to those skilled in the art. The headset may also be patched directly into or connected to the signal receiving means by a standard audio connecting cord connection between the headset and the signal receiving means and audio communicated from the signal receiving means to the headset.

The invention is also capable of establishing a communication line between the individuals tasked with moving the VLO using the headset and receiver via cord or wireless. When the warning system is triggered the audio alarm will override the communication line established between the individuals tasked with moving the VLO.

While the invention has been described with a certain degree of particularity, it is to be noted that modifications may be made in the details of the invention's construction and the arrangement of its components without departing from the spirit and scope of this disclosure. It is understood that the invention is not limited to the embodiments set forth herein for the purposes of exemplification.

The invention claimed is:

1. A communication system, comprising:
a. Signal generating means adapted to generate and broadcast a signal;
b. Signal receiving means for receiving a signal generated by said signal generating means; and,
c. Alarm generating means cooperatively associated with and responsive to said signal receiving means and adapted to generate and communicate an alarm.

2. The communication system of claim 1, wherein said signal generating means is adapted to be connected to a hand held aircraft marshalling wand.

3. The communication system of claim 1, wherein said signal comprises an electromagnetic frequency of between approximately 1 Hz and 3000 GHz.

4. The communication system of claim 1, wherein said signal comprises a radio wave signal.

5. The communication system of claim 1, wherein said signal comprises a microwave signal.

6. The communication system of claim 1, wherein said signal receiving means is portable.

7. The communication system of claim 1, wherein said signal receiving means is a headset.

8. The communication system of claim 1, wherein said alarm comprises a sound.

9. The communication system of claim 8, wherein said sound is comprised of a siren.

10. The communication system of claim 8, wherein said sound is comprised of spoken words.

11. The communication system of claim 1, wherein said alarm comprises a light.

12. The communication system of claim 1, wherein said alarm comprises a sound and a light.

13. A communication system, comprising:
a. Signal generating adapted to generate and broadcast a signal with an electromagnetic frequency of between approximately 1 Hz and 3000 GHz;
b. Signal receiving means for receiving a signal generated by said signal generating means; and,
c. Alarm generating means cooperatively associated with and responsive to said signal receiving means and adapted to generate and communicate an alarm in the form of sound and/or light.

14. The communication system of claim 13, wherein said signal generating means is adapted to be connected to a hand held aircraft marshalling wand.

15. The communication system of claim 13, wherein said signal receiving means is portable.

16. The communication system of claim 13, wherein said signal receiving means is a headset.

17. The communication system of claim 13, wherein said sound is comprised of a siren.

18. The communication system of claim 13, wherein said sound is comprised of spoken words.
